(19) United States
(12) Patent Application Publication
(10) Pub. No.: US 2007/0096669 A1
(43) Pub. Date: May 3, 2007

(54) Apparatus and method for controlling rotation speed of a fan

(76) Inventors: Sung-Wen Chang, Guei-Shan Hsiang (TW); Sheng-Wen Chen, Guei-Shan Hsiang (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/413,943

(22) Filed: Apr. 27, 2006

(30) Foreign Application Priority Data
Oct. 27, 2005 (TW) 094137700

(51) Int. Cl. H02P 7/00

(52) U.S. Cl. 318/276

(57) ABSTRACT

An apparatus and method for controlling a rotation speed of a fan. A comparator is used to detect an analog signal driving the fan. When the analog signal is detected abnormal, a voltage generation circuit generates a particular voltage to maintain a lowest operation voltage of the fan. A protection circuit is provided to let the fan driven by the analog signal again by means of receiving a signal from a system the fan is disposed at when the analog signal becomes normal.

### CROSS-REFERENCES TO RELATED APPLICATIONS

This application claims priority to Taiwan Patent Application No. 094137700 filed on Oct. 27, 2005.

### BACKGROUND OF THE INVENTION

1. Field of the Invention

The present invention relates to an apparatus and a method for controlling rotation speed of a fan; more particularly, relates to an apparatus and a method for providing a steady voltage to avoid a fan out of control when a voltage for controlling the fan is abnormal.

2. Descriptions of the Related Art

In recent years, because of the progress of information technique, the quality of the related products is highly improved. However, heat problem of these products also becomes serious. Therefore, highly-efficient cooling solutions are an important issue for new products. The most popular solution is to implant a system for controlling a rotation speed of a fan. The system may dynamically adjust the rotation speed of the fan to meet the need of cooling according to the environment temperature.

FIG. 1 is a schematic view illustrating a rotation speed controlling system for a fan of the prior art. The system comprises a pulse width modulation (PWM) circuit 10 and a digital/analog converter 12. The PWM circuit 10 is used to receive a digital control signal 11 for dynamically adjusting the rotation speed of a fan 14 via an Inter-Integrated Circuit (12C) bus. The digital control signal 11 is converted to a modulation signal 13 by the PWM circuit 10. The digital/analog converter 12 receives the modulation signal 13 and converts the modulation signal 13 into an analog signal 15. The analog signal 15 has a voltage for controlling the rotation speed of the fan 14. If the environment temperature gets high, the voltage of the analog signal 15 is then increased so that the rotation speed of the fan 14 becomes faster. If the environment temperature gets low, the voltage of the analog signal 15 is decreased so that the rotation speed of the fan 14 becomes slower.

Since the products protected by such a rotation speed controlling system are usually electronic devices with high prices, e.g., an optical projector, a micro-processor, an image processing accelerator and a digital signal processor, the loss resulting from over-heat will be huge if either the PWM circuit 10 or the analog/digital converter 12 malfunctions to make the fan 14 stop running. FIG. 2 illustrates the voltage of the analog signal 15 of the rotation speed controlling system, wherein V denotes voltage, T denotes time and Vout denotes the voltage of the analog signal 15. Under normal circumstances, the analog signal 15 is between 7V and 12V. If an abnormal situation occurs, the analog signal 15 might go down to 0V. The fan 14 stops running when the analog signal 15 is 0V. The environment temperature, hence, becomes higher. It causes such important and high-price devices to malfunction once the environment temperature exceeds their operating temperature. Of course, the whole system will operate abnormal thereby. Consequently, a solution for maintaining normal operation of a fan even in abnormal circumstances is still desired.

### SUMMARY OF THE INVENTION

The primary object of this invention is to provide an apparatus for controlling a rotation speed of a fan according to an analog signal, wherein the analog signal is used to control the rotation speed of the fan. The apparatus of this invention can detect an abnormal condition according to the analog signal in order to control the fan maintaining operation when the abnormal condition causes the analog signal abnormal.

The apparatus of this invention comprises a comparator and a voltage generation circuit. The analog signal has a voltage. The comparator is configured to compare the analog signal and a reference voltage to generate a comparison signal. The voltage generation circuit is configured to receive the comparison signal. The voltage generation circuit generates a particular voltage to control the rotation speed if the comparison signal indicates abnormality of the analog signal, wherein the particular voltage may be a lowest voltage for maintaining operation of the fan.

The apparatus of this invention further comprises a PWM circuit, a digital/analog converter, and a protection circuit. The PWM circuit is configured to generate a modulation signal. The digital/analog converter is configured to receive the modulation signal to generate the analog signal. The protection circuit is configured to control the modulation signal according to the comparison signal; more particularly, is configured to restrain the digital/analog converter from receiving the modulation signal.

Another object of this invention is to provide a method for controlling a rotation speed of a fan. The method comprises the following steps: receiving an analog signal, wherein the analog signal determines the rotation speed; receiving a reference voltage; determining whether the analog signal is lower than the reference voltage; and generating a particular voltage to control the rotation speed if the analog signal is determined lower than the reference voltage.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a rotation speed controlling system for a fan of the prior art;

FIG. 2 illustrates variation of a voltage for controlling a fan of the prior art;

FIG. 3 illustrates a first embodiment of the present invention;

FIG. 4 illustrates a second embodiment of the present invention;

FIG. 5 illustrates variation of a voltage for controlling a fan in accordance with the present invention; and

FIG. 6 is a flow chart of a method in accordance with the present invention.

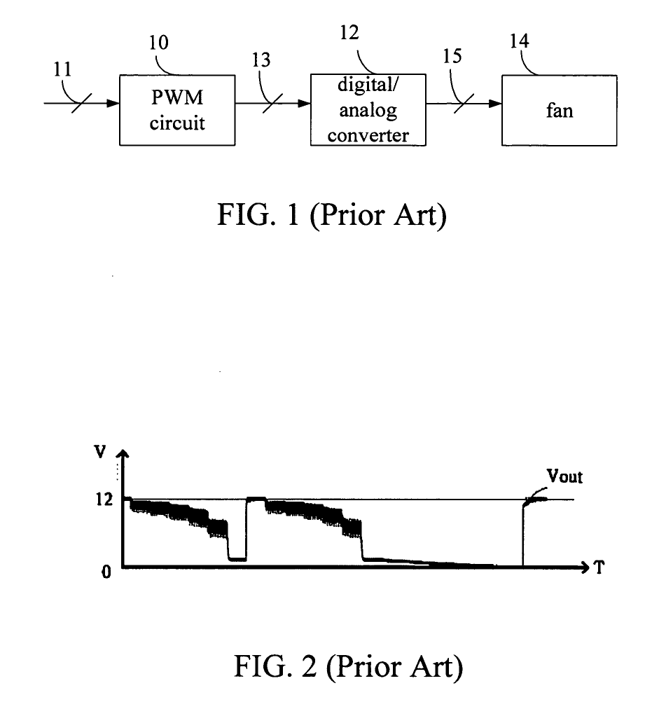

### DESCRIPTION OF THE PREFERRED EMBODIMENT

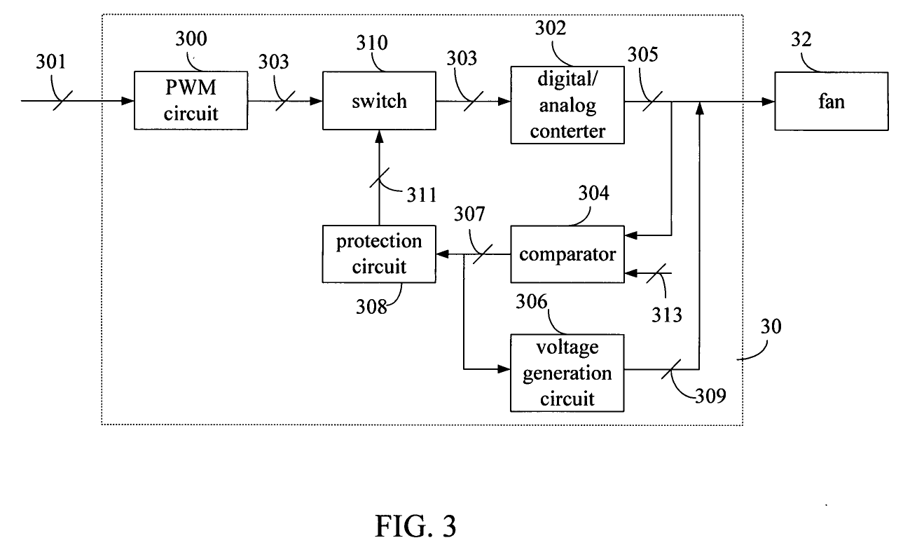

A first embodiment of the present invention shown in FIG. 3 is an apparatus 30 for controlling a rotation speed of a fan 32 according to an analog signal. The apparatus 30 is embedded in a system, such as a projector. The fan 32 is configured to emit heat air out of the system to lower the environment temperature. The apparatus 30 comprises a PWM circuit 300, a digital/analog converter 302, a comparator 304, a voltage generation circuit 306, a protection circuit 308, and a switch 310. The PWM circuit 300 receives a digital signal 301 which is generated according to the environment temperature of the system. The digital signal 301 is converted to a modulation signal 303 by the PWM circuit 300. The digital/analog converter 302 receives the modulation signal 303 via the switch 310 when the switch 310 is ON and converts the modulation signal 303 into an analog signal 305. The analog signal 305 has a voltage, from 7V to 12V, for controlling the rotation speed of the fan 32 under a normal operation of the apparatus 30. The rotation speed of the fan 32 becomes faster if the voltage of the analog signal 305 is increased. The rotation speed of the fan 32 becomes slower if the voltage of the analog signal 305 is decreased.

One input end of the comparator 304 receives the analog signal 305 and the other input end receives a reference voltage 313. The reference voltage 313, providing as a basis for comparison, is 7V in this embodiment. The comparator 304 compares the voltages of the analog signal 305 and the reference voltage 313. If the analog signal 305 is higher than the reference voltage 313, it means that the PWM circuit 300, the digital/analog converter 302 or other apparatuses associated with controlling the rotation speed of the fan 32 in the system operate normally. An output signal 307 of the comparator 304 has, therefore, a high level. After receiving the high level signal 307, an output end of the voltage generation circuit 306, i.e., a linear voltage regulator becomes high impedance; this means a signal 309 does not exist. Accordingly, the analog signal 305 drives the fan 32 to rotate. Meanwhile, the protection circuit 308 also receives the high level signal 307 and outputs a high level signal 311 to the switch 310. The switch 310 keeps ON in response to the signal 311. The modulation signal 303, hence, continues inputting to the digital/analog circuit 302.

If the analog signal 305 is lower than the reference voltage 313, it means that the PWM circuit 300, the digital/analog converter 302 or the other apparatuses associated with controlling the rotation speed of the fan 32 operate abnormally. The output signal 307 of the comparator 304 turns to a low level. After receiving the low level signal 307, the output signal 309 of the voltage generation circuit 306 is set 6V. The protection circuit 308 also receives the low level signal 307 and outputs the low level signal 311 to the switch 310. This is for restraining the digital/analog converter 302 from receiving the modulation signal 303. The switch 310 is now OFF in response to the signal 311 so that the modulation signal 303 cannot be inputted to the digital/analog converter 302. The analog signal 305, hence, has no level. The 6V signal 309 drives the fan 32 to rotate. Once the analog signal 305 returns normal, the protection circuit 308, comprising a switch, will release the restraint.

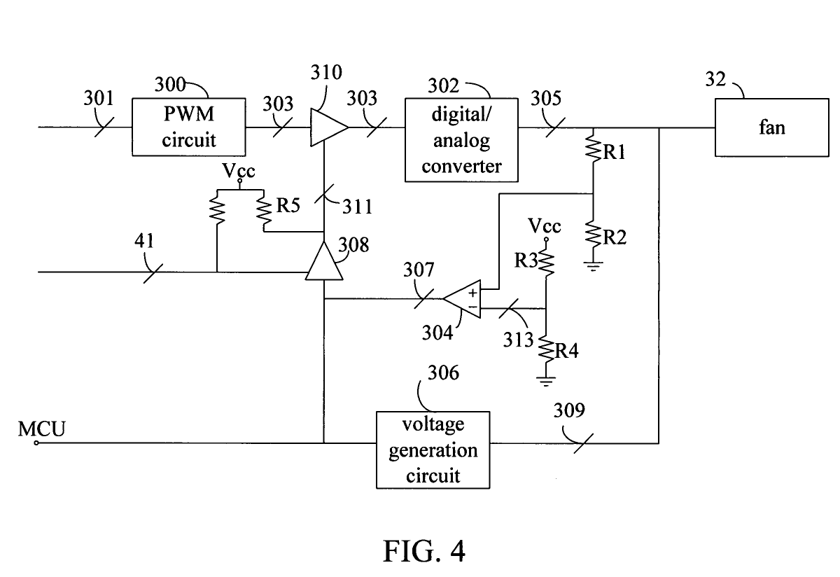

FIG. 4 shows a circuit diagram of a second embodiment of the present invention. In contrast with the first embodiment, the analog signal 305 of the second embodiment is divided by series resistances R1, R2 and then is inputted to the comparator 304. The reference voltage 313 is derived from Vcc divided by series resistances R3, R4. The two divided voltages inputted into the comparator 304 are used to save power. They may be selected by determining the values of the resistances R1, R2, R3 and R4.

Moreover, a switch control end of the switch 310 of the second embodiment is connected to Vcc via a resistance R5. In other words, the switch control end of the switch 310 always stays with a high voltage so that the switch 310 is always ON. Therefore, the digital/analog converter 302 can receive the modulation signal 303 via the switch 310 all the time. The protection circuit 308 is a switch, which is controlled by a signal 41 generated from the system. More specifically, when the above-mentioned abnormal condition happens, the output signal 307 of the comparator 304 has a low level. The output signal 307 is transmitted to a processor (not shown) through a MCU end. The signal 41 is transmitted to the protection circuit 308 when the processor finds the abnormality of the analog signal 305. The signal 41 having a low level turns off the protection circuit 308. The protection circuit 308, hence, has no output signal, and the switch 310 keeps ON. Meanwhile, the signal 309 outputted by the voltage generation circuit 306 pulls up the voltage transmitted to the fan 32 to 6V in order to maintain a minimum rotation speed of the fan 32.

The processor resets the digital signal 301 to recover the analog signal 305 when finding the abnormality of the analog signal 305. If the analog signal 305 returns normal, then the output signal 307 of the comparator 304 comes back to high. After the processor receives the high level output signal 307, the signal 41 is adjusted to a high level. The protection circuit 308 turns ON. The signal 311 is high in response to the signal 307 and outputted to the switch control end of the switch 310.

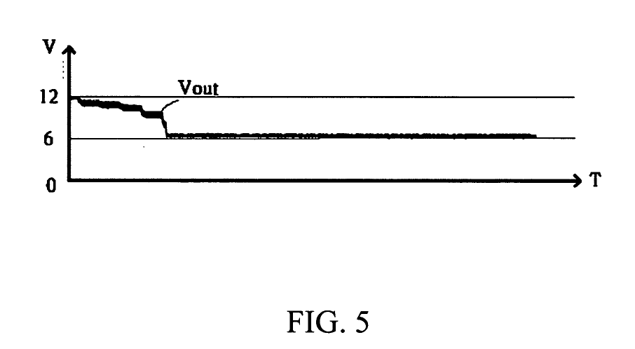

As shown in FIG. 5, the present invention maintains the voltage for controlling the rotation speed of the fan 32 in at least 6V. Even if the PWM circuit 300, the digital/analog converter 302 or the other apparatuses associated with controlling the rotation speed of the fan 32 operate abnormally, the fan 32 may continue running. Accordingly, the environment temperature will not increase quickly. The object of cooling is achieved.

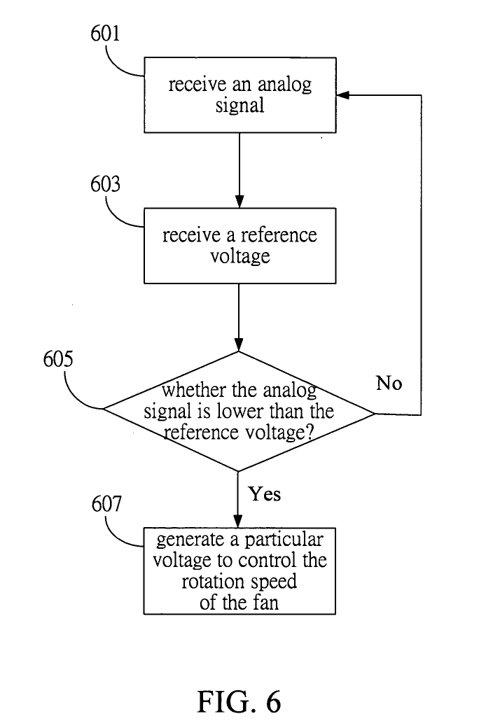

A method for controlling a rotation speed of a fan is shown in FIG. 6. In step 601, the fan receives an analog signal to determine the rotation speed of the fan. Then step 603 is executed wherein an apparatus of this invention receives a reference voltage. Then step 605 is executed wherein a comparator determines whether the analog signal is lower than the reference voltage. If not, it means the analog signal is normal so the method returns to step 601 to continue receiving an analog signal. If yes, it means the analog signal is abnormal so step 607 is executed wherein a voltage generation circuit generates a particular voltage to control the rotation speed of the fan. As mentioned above, the particular voltage may be a lowest voltage for maintaining operation of the fan.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An apparatus for controlling a rotation speed of a fan according to an analog signal, comprising:
a comparator for comparing the analog signal and a reference voltage to generate a comparison signal; and
a voltage generation circuit for generating a particular voltage to control the rotation speed if the comparison signal indicates abnormality of the analog signal.

2. The apparatus as claimed in claim 1, further comprising a digital/analog converter for receiving a modulation signal and generating the analog signal.

3. The apparatus as claimed in claim 2, further comprising a protection circuit for restraining the digital/analog converter from receiving the modulation signal according to the comparison signal.

4. The apparatus as claimed in claim 3, wherein the protection circuit comprises a switch for releasing the restraint.

5. The apparatus as claimed in claim 2, further comprising a pulse width modulation circuit for generating the modulation signal.

6. The apparatus as claimed in claim 1, wherein the particular voltage is a lowest voltage for maintaining operation of the fan.

7. The apparatus as claimed in claim 1, wherein the voltage generation circuit is a linear voltage regulator.

8. A method for controlling a rotation speed of a fan, comprising the following steps:
receiving an analog signal, the analog signal determining the rotation speed;
receiving a reference voltage;
determining whether the analog signal is lower than the reference voltage; and
generating a particular voltage to control the rotation speed if the analog voltage is determined lower than the reference voltage.

9. The method as claimed in claim 8, wherein the particular voltage is a lowest voltage for maintaining operation of the fan.
